(19) United States
(12) Patent Application Publication
(10) Pub. No.: US 2020/0334327 A1
(43) Pub. Date: Oct. 22, 2020

(54) METHOD TO AUTOMATE PROCESSING FORM INPUT TO OTHER SYSTEMS

(71) Applicant: Wei YANG, Singapore (SG)

(72) Inventor: Wei YANG, Singapore (SG)

(21) Appl. No.: 16/386,240

(22) Filed: Apr. 16, 2019

(51) Int. Cl. G06F 17/24; G06F 16/93

(52) U.S. Cl. CPC G06F 17/243; G06F 3/0484; G06F 16/93

(57) ABSTRACT

Embodiments of the invention provide a technical solution by creating a new meta-structure for a document such that, before the document is opened or executed by a client application, the meta-structure may reveal form contents or a portion of the form contents to the user in response to a selection by the user. In one embodiment, the meta-structure may be separate from metadata fields already recognized or established by the document.

### TECHNICAL FIELD

Embodiments of the invention generally relate to bridging formed contents between different systems.

### BACKGROUND

Automation of form data generation and electronic exchange of form data have been common since computers are able to transmit and receive form contents. As such, online forms are common practices now for many industries.

However, some of the industries still rely on exchange of forms sent via emails or text messaging. While arguments may be made to upgrade such systems, the confidential nature of the forms themselves may sometimes preclude these forms to be made available in an online environment.

In such form exchanging systems, it is critical that form content extraction or identification system performs accurately. Current practice involves the recipient of the form sent via email would open the file using a client application so that the form contents are reveal in the client application. The recipient would then manually identify and extract a portion of the form content to another form or application.

Unfortunately, such manual transfer of information is prone to human errors, not to mention the human labor costs.

Therefore, to reduce error rate and human costs associated with human intervention, embodiments of the invention attempt to technically solve or address one or more of the technical problems identified above.

### SUMMARY

Embodiments of the invention provide a technical solution by creating a new meta-structure for a document such that, before the document is opened or executed by a client application, the meta-structure may reveal form contents or a portion of the form contents to the user in response to a selection by the user. In one embodiment, the meta-structure may be separate from metadata fields already recognized or established by the document.

In another embodiment, the meta-structure is independent of the document's format or encoding. In one embodiment, the identification of the meta-structure is automatic in response to an interaction between the document and the user. In another embodiment, the identification of contents of the meta-structure may be automatic, once the meta-structure is identified or recognized or once the user instructs the revelation. In a further embodiment, the meta-structure may be responsive to platform graphical user interface (GUI) libraries.

### BRIEF DESCRIPTION OF THE DRAWINGS

Persons of ordinary skill in the art may appreciate that elements in the figures are illustrated for simplicity and clarity so not all connections and options have been shown to avoid obscuring the inventive aspects. For example, common but well-understood elements that are useful or necessary in a commercially feasible embodiment may often not be depicted in order to facilitate a less obstructed view of these various embodiments of the present disclosure. It will be further appreciated that certain actions and/or steps may be described or depicted in a particular order of occurrence while those skilled in the art will understand that such specificity with respect to sequence is not actually required. It will also be understood that the terms and expressions used herein may be defined with respect to their corresponding respective areas of inquiry and study except where specific meanings have otherwise been set forth herein.

FIG. 1 is a diagram illustrating a form content presentation system according to one embodiment of the invention.

FIG. 2 is a diagram illustrating an exemplary form content according to one embodiment of the invention.

FIG. 3 is an exemplary meta-structure data content generated by a meta-structure generator according to one embodiment of the invention.

FIG. 4 is exemplary declaration statements associated with a meta-structure according to one embodiment of the invention.

FIG. 5A-5F are diagrams illustrating exemplary meta-structure revealed on a receiver's device according to one embodiment of the invention.

FIG. 6 is a diagram illustrating a data structure of a meta-structure according to one embodiment of the invention.

FIG. 7A is a flow chart illustrating a method for generating a meta-structure according to one embodiment of the invention.

FIG. 7B is a flow chart illustrating a method for retrieval of a meta-structure according to one embodiment of the invention.

FIG. 8 is a diagram illustrating a portable computing device according to one embodiment of the invention.

FIG. 9 is a diagram illustrating a remote computing device according to one embodiment of the invention.

### DETAILED DESCRIPTION

The present invention may now be described more fully with reference to the accompanying drawings, which form a part hereof, and which show, by way of illustration, specific exemplary embodiments by which the invention may be practiced. These illustrations and exemplary embodiments may be presented with the understanding that the present disclosure is an exemplification of the principles of one or more inventions and may not be intended to limit any one of the inventions to the embodiments illustrated. The invention may be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods, systems, computer readable media, apparatuses, or devices. Accordingly, the present invention may take the form of an entirely hardware embodiment, an entirely software embodiment, or an embodiment combining software and hardware aspects. The following detailed description may, therefore, not to be taken in a limiting sense.

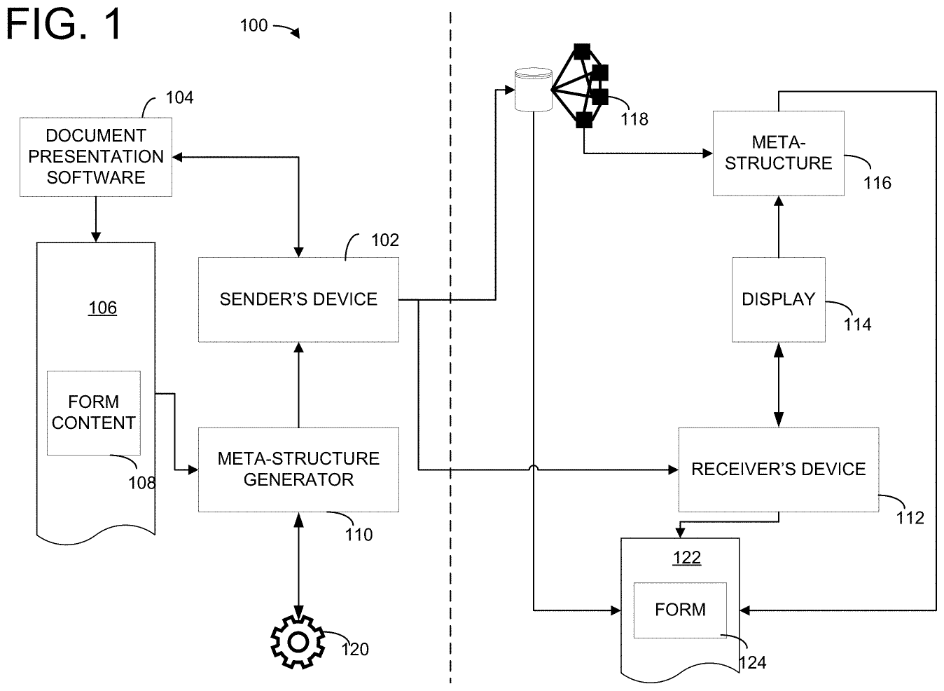

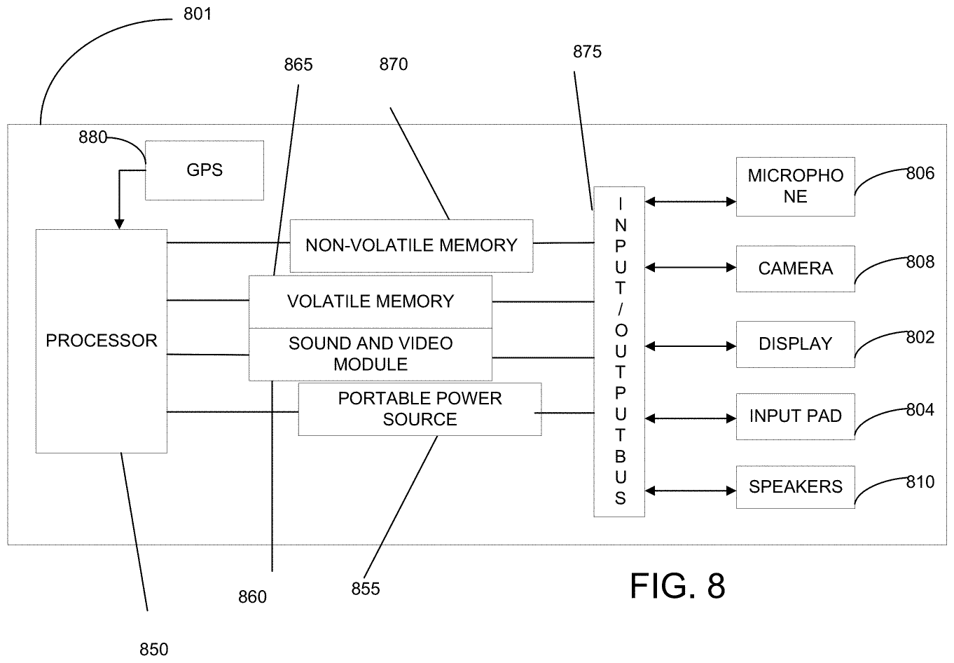

Referring to now FIG. 1, a system 100 provides a system overview of a meta-structure generation and presentation according to one embodiment of the invention. For example, the system 100 includes a user device 102. In one embodiment, the user device 102 may be a sender device, which may be a laptop, a desktop computer, a workstation or the like. In another embodiment, the user device 102 may be a smartphone or mobile device such as a portal computing device 801 described in FIG. 8. In another embodiment, the user device 102 may also have access to a document presentation software 104. In one example, the document presentation software 104 may also be referred to as an app 104 installed thereon. In a further embodiment, the document presentation software 104 may be served to the user device 102 or received by the user device 102 wirelessly. For example, the user device 102 may retrieve the document presentation software 104 from a remote server by visiting a website or a portal. The remote server may serve the software 104 as a service to the user device 102.

In one embodiment, the software 104 may be capable of editing, presenting, rendering, storing, saving, etc., contents of a document 106. In addition, the software 104 may at least enable editing, presenting, rendering, storing, saving, etc., form content 108 of the document 106.

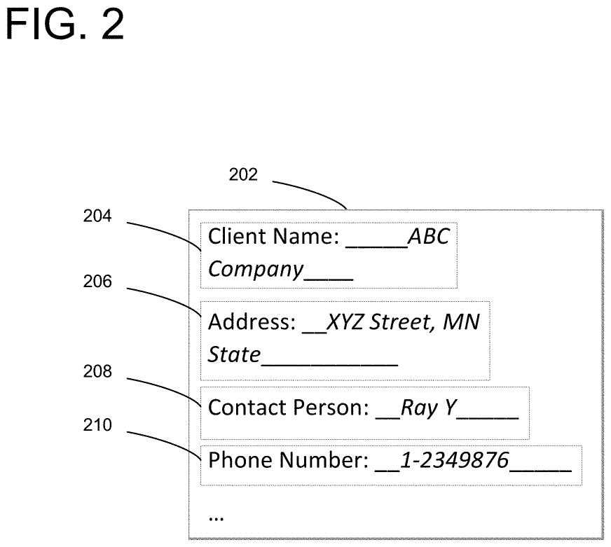

In one aspect of the invention, a user (not shown) may use the software 104 to create or edit the document 106. In one embodiment, the document 106 may include form content, such as those shown in FIG. 2. For example, a form content 202 may include field data or contents. For example, the form content 202 may include:

client name data 204;

address data: 206;

contact person data 208; and

phone number data 210.

It is to be understood that other data or contents from the form content 202 may be created or generated without departing from the scope or spirit of embodiments of the invention.

Instead of prior approaches where the entire document 106 is transmitted or exchanged between a sender and a recipient, embodiments of the invention create and generate a separate and distinct meta-structure that stores and presents the form contents in its entirety or only a portion thereof without the document 106 being opened or rendered by the software 104.

Referring to FIG. 1 again, the system 100 includes a meta-structure generator 110. In one example, the meta-structure generator 110 may be implemented as a plug-in to the software 104. For example, in one embodiment, the software 104 may include be Microsoft® Word software or Adobe® Acrobat® software. The software 104 may allow plug-in, add-on, or other third-party or supplementary injection of software or program to supplement the software 104. In this aspect of the invention, the generator 110 is activated or permitted to be executed within the execution environment of the software 104. Within such condition, the generator 110 first identifies the various form contents and the data entered or generated in the data fields of the form. For example, the document may have forms in various sections and the generator 110 may only be interested in a portion of the forms. As such, the generator 110 may identify portions of the document and note in the meta-structure. For example, in a structured document such as HTML, XML, or other mark-up language, the document defines or declares document contents and sections. As such, the generator 110 may scan through the document 106 for form fields and extract or identify form content or data.

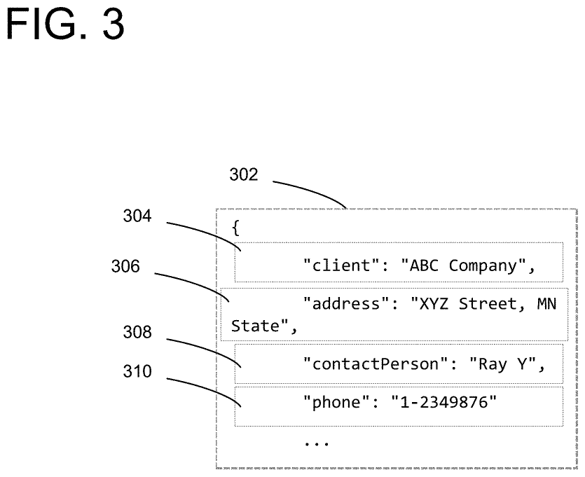

In another embodiment, the generator 110 may assign a label to each of the fields. Referring now to FIG. 3, as an example, an exemplary conversion from the form content 108 in FIG. 2. For example, the generator 110 may create a structured content envelope (e.g., as shown by the “{” symbol) and provide labels or tags for the data:

ABC Company 304;

XYZ Street, MN State 306;

Ray Y 308 and

1-2349876 310; to correspond to “client,” “address,” “contactPerson,” and “phone.”

In one embodiment, the generator 110 may close a given structured content envelope with a symbol “}” to denote the end of the section or form content data. It is to be understood that FIG. 3 is shown as an example (i.e., without the closing curly bracket “}”).

In one embodiment, the generator 110 may generate the meta-structure 116, such as the structure shown in FIG. 3 using a format such as JavaScript Object Notation (JSON) or XML. In other words, according one embodiment of the invention, the meta-structure 116 generated by the generator 110 may be in the same format as the document 106.

Referring back to FIG. 1, in one embodiment, before the document 106 is saved or closed by the software 104, the generator 110 may complete the generation of the meta-structure 116. For example, the software 104 may display an indicia to the user that the generator 110 may still be running. In another embodiment, the generator 110 may be composing or generating the meta-structure 116 in the background or simultaneously as the form data is entered, so that the user is not interrupted or delayed while the generator 110 is running.

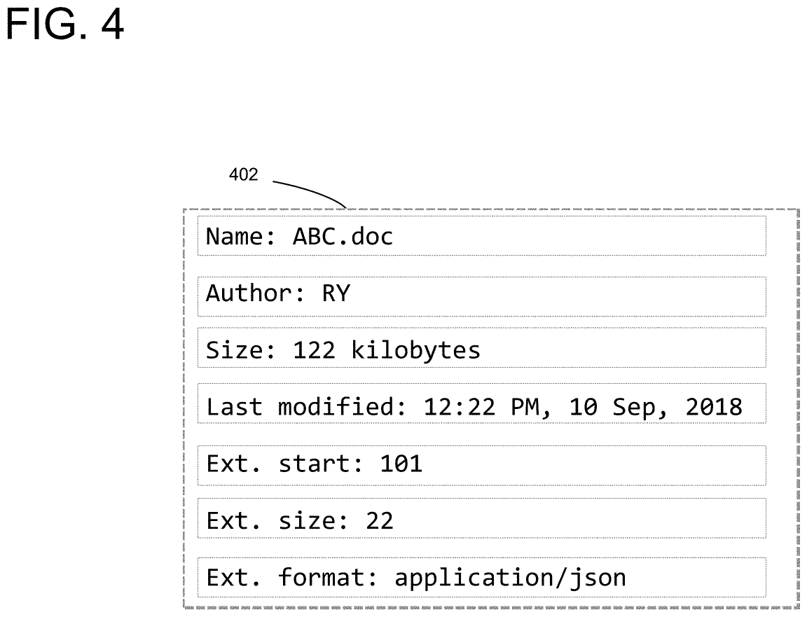

Once the generator 110 completes the generation of the meta-structure or once the document 106 is closed by the software, the meta-structure 116 may be available for extraction by a third-party system 118 or a receiver's user device 112. For example, referring now to FIG. 4, a sample declaration 402 of the meta-structure may be provided as part of the meta-structure 116. For example, the declaration 402 may provide a summary-like information as shown in FIG. 4, such as:

Name: ABC.doc

Author: RY

Size: 122 kilobytes

Last modified: 12:22 pm, 10 Sep. 2018

Ext. start: 101

Ext. size: 22

Ext. format: application/json.

In one embodiment, the meta-structure 116 may be regarded also as an extension (ext.) structure having extension data, that is the meta-structure 116 content. In another embodiment, the generator 110 may further provide a portal or a configuration setting 120 to allow the user or an administrator of the generator 110 to fine-tune the generator 110 or to provide customization to the generator 110.

For example, the sender's user device 102 may send the document 106 over to the receiver's user device 112, which may be similar to those of the sender's user device 102. In this aspect, the receiver's user device 112 may be connected to a display 114 and/or other input devices (not shown). Upon receiving the document and without executing it or opening it using the software 104 (which would need to be either installed on the receiver's user device 112 or accessed by the receiver's user device 112), the receiver's user device 112 may access the meta-structure 116 directly. Aspects of the invention incorporate standard structured data format, such as JSON and XML, into the meta-structure 116 so that the meta-structure 116 may be discovered, understood, read, or rendered without additional software or program injections.

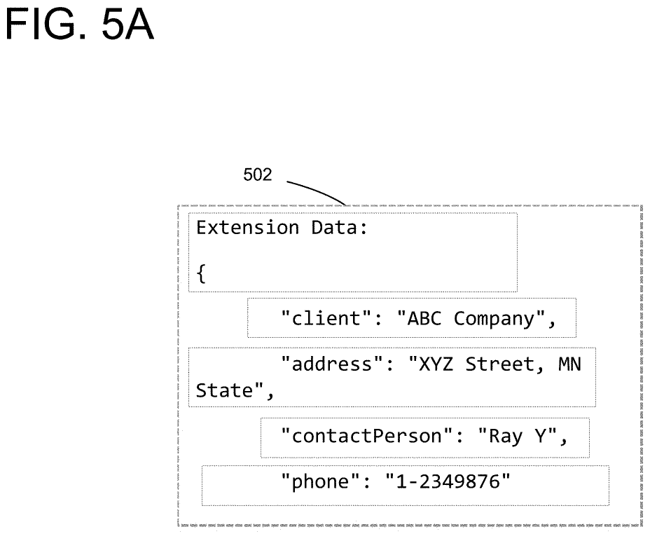

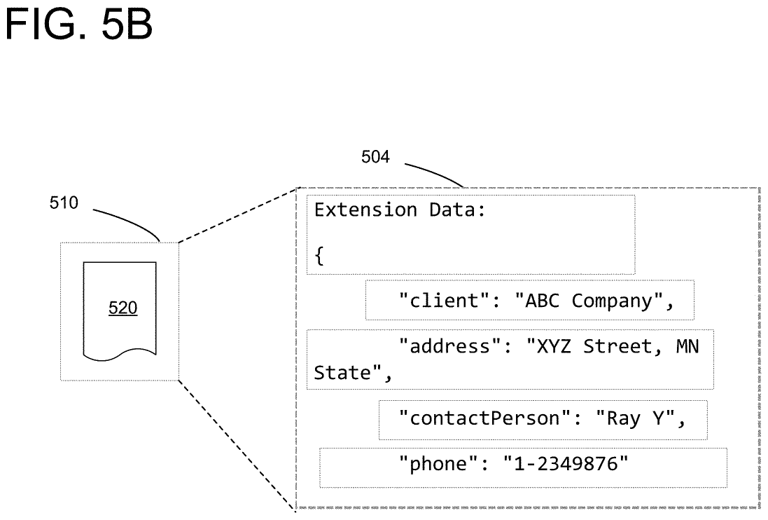

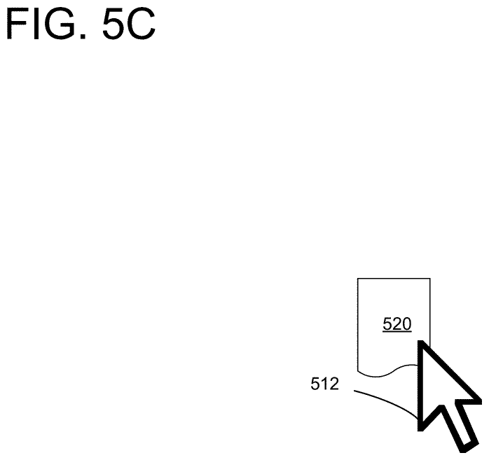

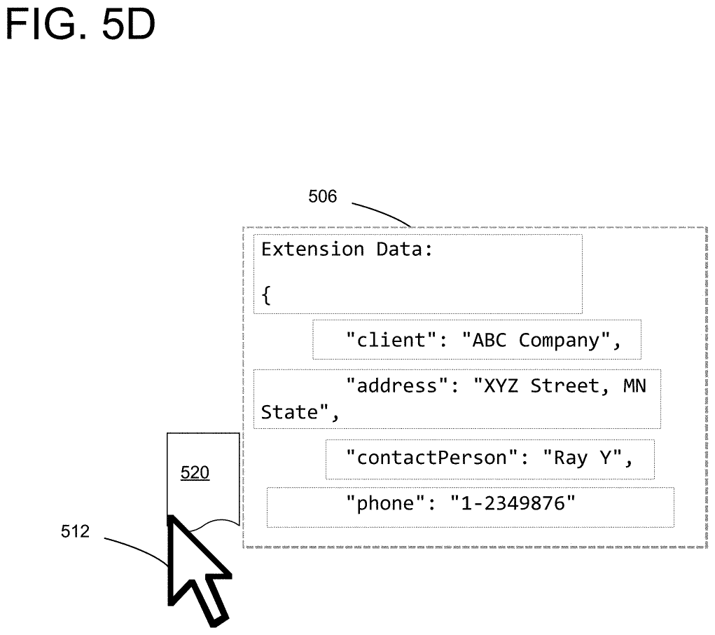

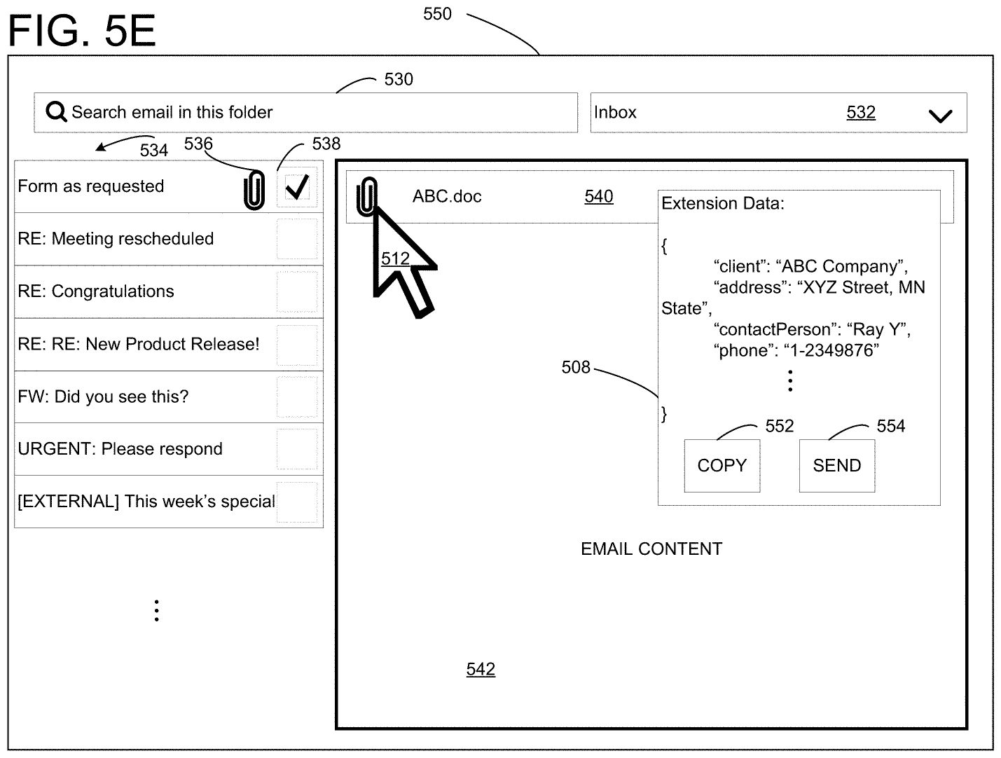

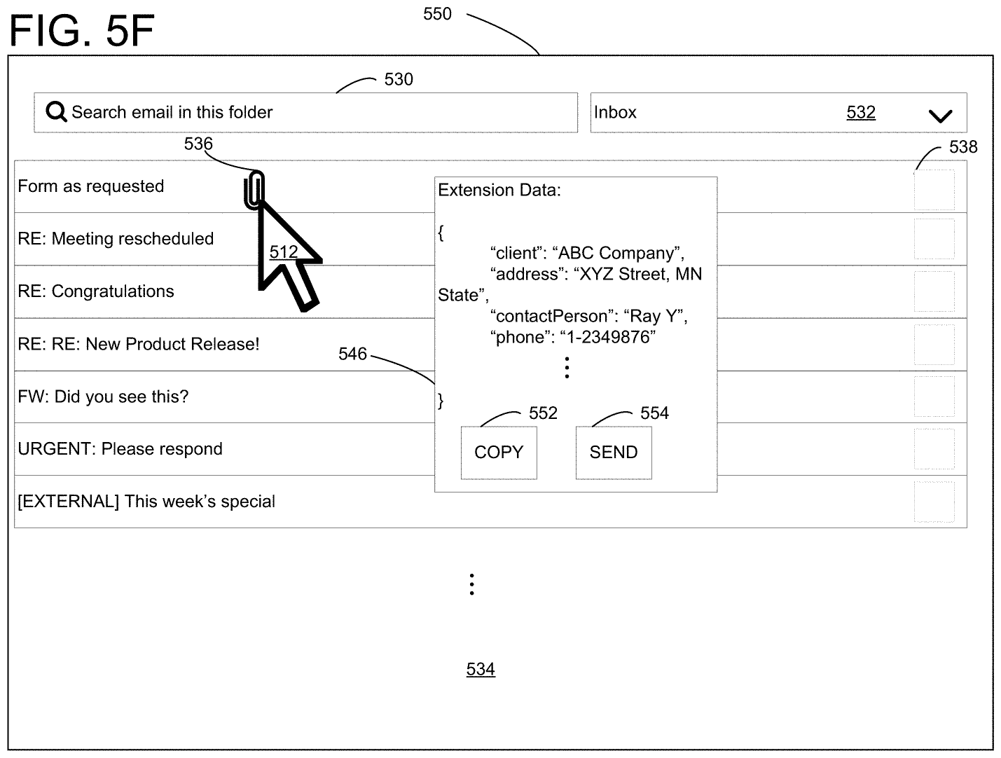

As such, at the receiver's user device 112 or the third party system 118, instead of having the user to execute or activate the software 104 to read or display the entire content of the document 106, the receiver's user device 112 may selectively view only the data content of the meta-structure 116. For example, referring to FIG. 5A, an exemplary meta-structure content 502 is illustrated according to one embodiment of the invention. In one example, the meta-structure or extension data 502 may be presented in a window-based container either by the system (e.g., system 118, the devices 112 or 102) or by the meta-structure generator 110, which is capable of both generating the meta-structure and reading the contents of the meta-structure. In one example, referring to FIG. 5B, a window 504 displaying the meta-structure 116 may be triggered by a selection 510, not an execution or activation, of the document 106 in its entirety. For example, the document 106, represented by an icon 520, may be selected by a user using a number of input device, such as a mouse, a keyboard, a stylus, his or her finger, or a voice command. The selection 510 may be reflected as a result of a click of the input device, a tap by the user's finger, or a voice command matching the selection. Upon selection 510 of the icon 520 of the document 106, the meta-structure 116 may be displayed in the window 504.

Referring to FIG. 5C, the meta-structure 116 may displayed in response to having an indicia hovering the icon 520. For example, in FIG. 5C, a mouse cursor 512 may hover over the icon 520. In response to the hovering action of the cursor 512 over the icon 520, a window 506 may display or render the meta-structure 116 immediately or after a short delay, as illustrated in FIG. 5D.

In a further embodiment, the meta-structure 116 may displayed or rendered in an email environment. For example, FIG. 5E illustrates graphical user interface (GUI) of an email execution environment 550. For example the environment 550 may be a client application for an email software capable of receiving, sending, editing, etc., to an email message. In another example, the environment 550 may be a browser environment where the user logs in to a web-based email system for retrieving, reading, editing, creating, etc., email messages. The environment 550 may also capable of attaching a document or receiving an email message with an attachment that is a document. In this environment, the environment 550 may also provide a search bar 530 for searching email messages or contents within the email messages, a folder selection bar 532 to limit or filter the scope of the search in the search bar 530. The environment 550 may also include a list of email messages 534 where one or more lines of the email messages may be displayed. In this illustration, only the first line of each email message is displayed. For the first line displayed in the list 534, the environment 550 further display an icon 536 to indicate whether the message in the list includes an attachment, and a selection box 538 for the user to select the message so that the content of the email message may be displayed in an email content pane 542. Upon selection of the box 538, the content of the email is displayed in the pane 542 with the attachment icon 536 displayed in an attachment pane 540. As illustrated in FIG. 5D, the meta-structure 116 may be displayed in response to hovering of the mouse cursor, such as that of cursor 512.

As such, according to another embodiment, a window 508 displaying the meta-structure 116 may display the content of the meta-structure 116 upon the environment 550 detecting the mouse cursor 512 is hovering over the attachment icon 512. In another embodiment, the window 508 may further include two action buttons: a copy button 552 and a send button 554. In one example, the copy button 552 may enable the user to select and copy the content of the form in the meta-structure 116 for completion in another form in a different format, such as form 124 in a document 122. In another embodiment, the send button 554 may enable the user to select and send, without any additional human instructions or interactions, to the third party system 118 that is pre-configured to receive the form content or data included in the meta-structure 116 such that the user may not be able to alter the format from the meta-structure 116 to the new document 112 having a separate form 124. The environment 550 may further provide confirmation window or pop-ups; however, such features may be optional.

In a further embodiment, FIG. 5F illustrates another example of how conveniently the meta-structure 116 may be displayed. In this embodiment, the user may bypass the selection box 538. Instead, the user may only wish to review the content of the meta-structure 116. As such, the mouse cursor 512 may be hovered over the attachment icon 536 of the document 106. As the document 106 may include the form data, the environment 550 may recognize the existence of the meta-structure 116. In response, a window 546 is triggered to display the content of the meta-structure 116, along with the copy button 552 and the send button 554.

It is to be understood that although FIGS. 5E and 5F illustrate an example of an email message environment, other messaging environment may be used without departing from the scope or spirit of embodiments of the invention.

In another aspect, the third party system 118 or the receiver's device 112 may consume or process the meta-structure 116 by reading the declaration 402 as shown in FIG. 4 before providing the display platform or mechanism. For example, the system 118 or the device 112 may first determine the size of the content to determine the window size to be displayed. The system 118 or the device 112 may next call or activate JSON or XML, or whichever formatting platform the meta-structure 116 is using to be executed in the background before displaying the content in the meta-structure 116.

In another embodiment, the system 118 or the device 112 may further inject security measure in displaying the content. For example, the virus or malware detection program may be activated or triggered to evaluate the displayed content. For the examples in FIGS. 5E and 5F, the system 118 or the device 112 may a have separate container for the send button 554 as the send action may involve sending data for processing or execution. Therefore, the system 118, the user devices 102 and 112 may have data retrieval rules that may be first executed before revealing the contents of the meta-structure 116. Moreover, the meta-structure 116 may include data retrieval rules for retrieving data from the meta-structure 116.

Moreover, it is to be understood that the meta-structure generator 110 may be installed in the sender's device 102 for generating the meta-structure 116 and in the receiver's device 112 for reading the meta-structure 116. As such, the environments illustrated in FIGS. 5A to 5F may have the meta-structure generator 110 installed as an add-on program or any other means described above.

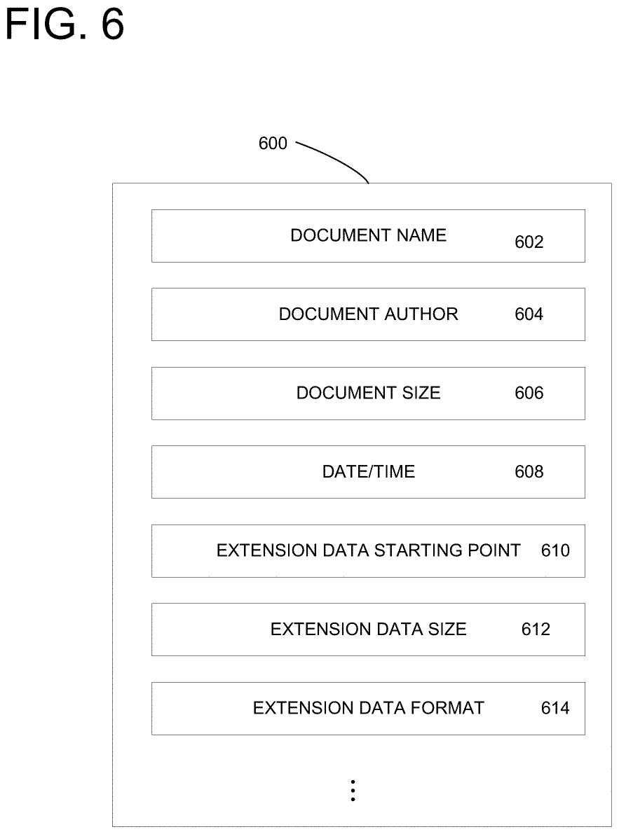

Referring now to FIG. 6, a diagram describing a data structure 600 for the declaration to be used in conjunction with the meta-structure 116. For example, the structure 600 includes the following fields:

Document name 602;

Document author 604;

Document size 606;

Date/Time 608;

Extension data starting point 610;

Extension data size 612; and

Extension data format 614.

In one embodiment, the Date/Time 608 field may store last modified time, creation time, etc. In another embodiment, the Extension data starting point field 610 may indicate a line number where the extension data or meta-structure data content starts. It is to be understood that other fields may be included, such as data retrieval rules, without departing from the scope or spirit of embodiments of the invention.

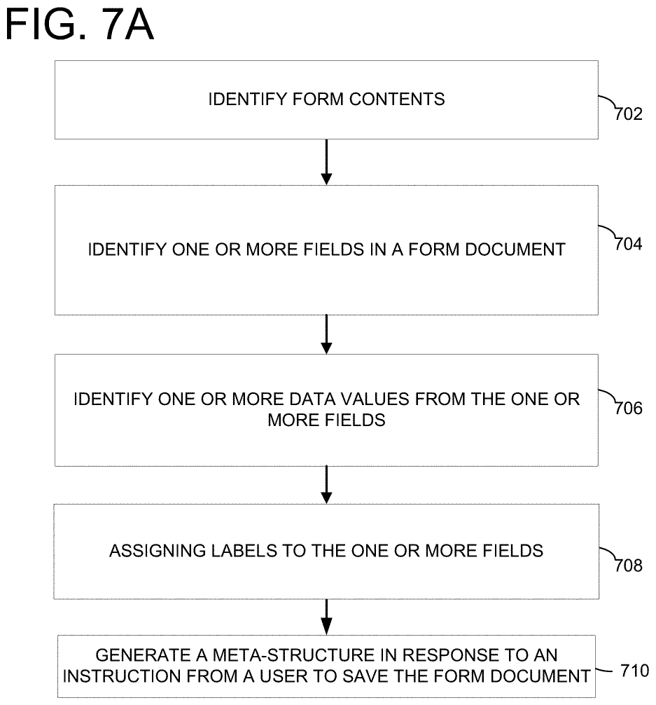

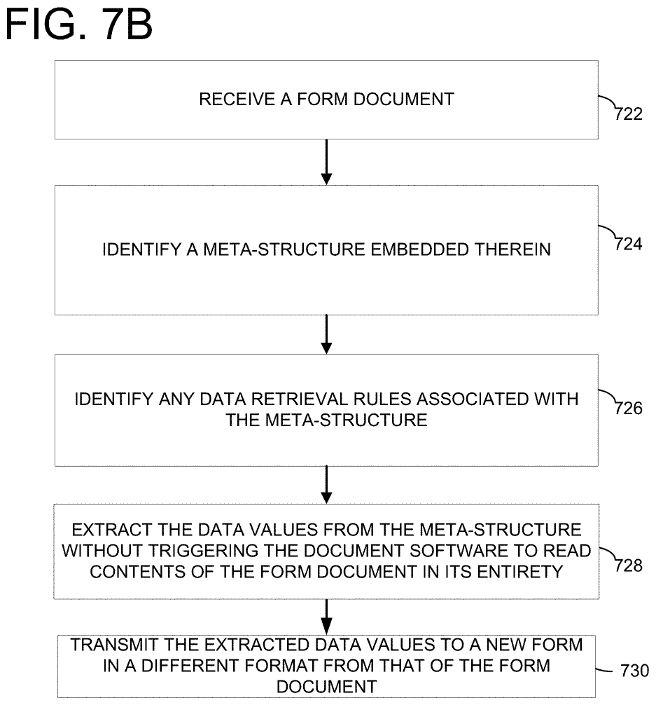

FIG. 7A illustrates a flow chart describing a method for generating a form document with a meta-structure according to one embodiment of the invention. For example, at 702, form contents or data are identified. In one embodiment, a system, such as those in the system 118, the device 102, or the device 112, may first identify whether the document is a form. At 704, one or more fields in the form document are identified. One or more data values from the one or more fields are further identified at 706. At 708, the one or more fields are labeled. At 710, a meta-structure is generated in response to an instruction from a user to save the form document. In another example, the meta-structure stores at least a portion of the data values and corresponding label. Moreover, the meta-structure and the contents thereof are embedded within the form document and are not visible to the user at the time of saving.

Referring now to FIG. 7B, a flow chart illustrating a method for retrieving data from the meta-structure according to one embodiment of the invention. At 722, a meta-structure generator 110 may receive a form document. Without calling the document software, such as software 104, to open the form document in its entirety, the meta-structure generator 110 may identify a meta-structure embedded in the form document at 724. At 726, the meta-structure generator 110 may identify any data retrieval rules associated with the meta-structure. The meta-structure generator 110 may then extract the data values from the meta-structure without triggering the document software 104 to read contents of the form document in its entirety at 728. Moreover, at 730, the meta-structure generator 110 may further transmit the extracted data values to a new form in a different form from that of the form document.

FIG. 8 may be a high level illustration of a portable computing device 801 communicating with a remote computing device 841 but the application may be stored and accessed in a variety of ways. In addition, the application may be obtained in a variety of ways such as from an app store, from a web site, from a store Wi-Fi system, etc. There may be various versions of the application to take advantage of the benefits of different computing devices, different languages, and different API platforms.

In one embodiment, a portable computing device 801 may be a mobile device 112 that operates using a portable power source 855 such as a battery. The portable computing device 801 may also have a display 802 which may or may not be a touch sensitive display. More specifically, the display 802 may have a capacitance sensor, for example, that may be used to provide input data to the portable computing device 801. In other embodiments, an input pad 804 such as arrows, scroll wheels, keyboards, etc., may be used to provide inputs to the portable computing device 801. In addition, the portable computing device 801 may have a microphone 806 which may accept and store verbal data, a camera 808 to accept images and a speaker 810 to communicate sounds.

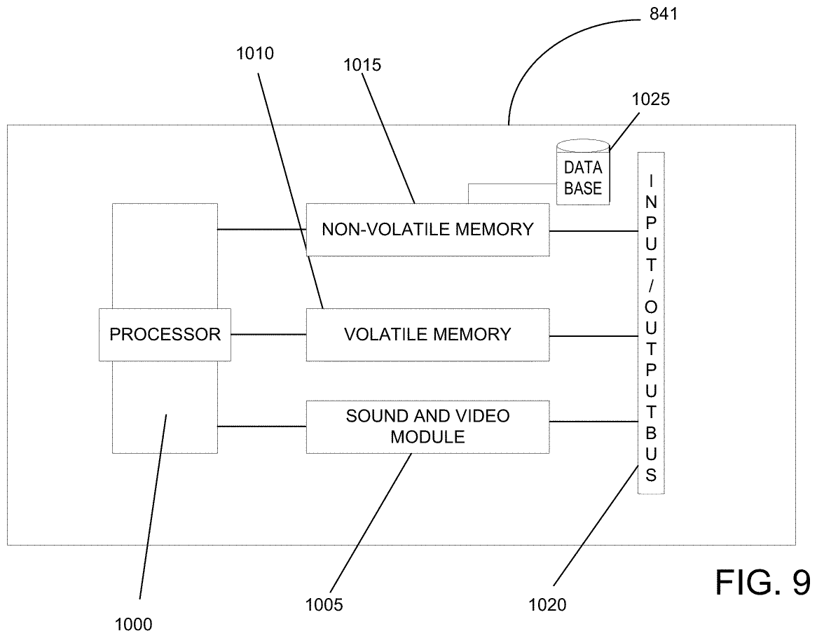

The portable computing device 801 may be able to communicate with a computing device 841 or a plurality of computing devices 841 that make up a cloud of computing devices 811. The portable computing device 801 may be able to communicate in a variety of ways. In some embodiments, the communication may be wired such as through an Ethernet cable, a USB cable or RJ6 cable. In other embodiments, the communication may be wireless such as through Wi-Fi (802.11 standard), Bluetooth, cellular communication or near field communication devices. The communication may be direct to the computing device 841 or may be through a communication network 102 such as cellular service, through the Internet, through a private network, through Bluetooth, etc. FIG. 8 may be a simplified illustration of the physical elements that make up a portable computing device 801 and FIG. 9 may be a simplified illustration of the physical elements that make up a server type computing device 841.

FIG. 8 may be a sample portable computing device 801 that is physically configured according to be part of the system. The portable computing device 801 may have a processor 850 that is physically configured according to computer executable instructions. It may have a portable power supply 855 such as a battery which may be rechargeable. It may also have a sound and video module 860 which assists in displaying video and sound and may turn off when not in use to conserve power and battery life. The portable computing device 801 may also have volatile memory 865 and non-volatile memory 870. It may have GPS capabilities 880 that may be a separate circuit or may be part of the processor 850. There also may be an input/output bus 875 that shuttles data to and from the various user input devices such as the microphone 806, the camera 808 and other inputs, such as the input pad 804, the display 802, and the speakers 810, etc. It also may control of communicating with the networks, either through wireless or wired devices. Of course, this is just one embodiment of the portable computing device 801 and the number and types of portable computing devices 801 is limited only by the imagination.

As a result of the system, better information may be provided to a user at a point of sale. The information may be user specific and may be required to be over a threshold of relevance. As a result, users may make better informed decisions. The system is more than just speeding a process but uses a computing system to achieve a better outcome.

The physical elements that make up the remote computing device 841 may be further illustrated in FIG. 9. At a high level, the computing device 841 may include a digital storage such as a magnetic disk, an optical disk, flash storage, non-volatile storage, etc. Structured data may be stored in the digital storage such as in a database. The server 841 may have a processor 1000 that is physically configured according to computer executable instructions. It may also have a sound and video module 1005 which assists in displaying video and sound and may turn off when not in use to conserve power and battery life. The server 841 may also have volatile memory 1010 and non-volatile memory 1015.

The database 1025 may be stored in the memory 1010 or 1015 or may be separate. The database 1025 may also be part of a cloud of computing device 841 and may be stored in a distributed manner across a plurality of computing devices 841. There also may be an input/output bus 1020 that shuttles data to and from the various user input devices such as the microphone 806, the camera 808, the inputs such as the input pad 804, the display 802, and the speakers 810, etc. The input/output bus 1020 also may control of communicating with the networks, either through wireless or wired devices. In some embodiments, the application may be on the local computing device 801 and in other embodiments, the application may be remote 841. Of course, this is just one embodiment of the server 841 and the number and types of portable computing devices 841 is limited only by the imagination.

The user devices, computers and servers described herein may be general purpose computers that may have, among other elements, a microprocessor (such as from the Intel Corporation, AMD, ARM, Qualcomm, or MediaTek); volatile and non-volatile memory; one or more mass storage devices (i.e., a hard drive); various user input devices, such as a mouse, a keyboard, or a microphone; and a video display system. The user devices, computers and servers described herein may be running on any one of many operating systems including, but not limited to WINDOWS, UNIX, LINUX, MAC OS, iOS, Android, or Windows (XP, VISTA, etc.). It is contemplated, however, that any suitable operating system may be used for the present invention. The servers may be a cluster of web servers, which may each be LINUX based and supported by a load balancer that decides which of the cluster of web servers should process a request based upon the current request-load of the available server(s).

The user devices, computers and servers described herein may communicate via networks, including the Internet, WAN, LAN, Wi-Fi, other computer networks (now known or invented in the future), and/or any combination of the foregoing. It should be understood by those of ordinary skill in the art having the present specification, drawings, and claims before them that networks may connect the various components over any combination of wired and wireless conduits, including copper, fiber optic, microwaves, and other forms of radio frequency, electrical and/or optical communication techniques. It should also be understood that any network may be connected to any other network in a different manner. The interconnections between computers and servers in system are examples. Any device described herein may communicate with any other device via one or more networks.

The example embodiments may include additional devices and networks beyond those shown. Further, the functionality described as being performed by one device may be distributed and performed by two or more devices. Multiple devices may also be combined into a single device, which may perform the functionality of the combined devices.

The various participants and elements described herein may operate one or more computer apparatuses to facilitate the functions described herein. Any of the elements in the above-described Figures, including any servers, user devices, or databases, may use any suitable number of subsystems to facilitate the functions described herein.

Any of the software components or functions described in this application, may be implemented as software code or computer readable instructions that may be executed by at least one processor using any suitable computer language such as, for example, Java, C++, or Perl using, for example, conventional or object-oriented techniques.

The software code may be stored as a series of instructions or commands on a non-transitory computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus and may be present on or within different computational apparatuses within a system or network.

It may be understood that the present invention as described above may be implemented in the form of control logic using computer software in a modular or integrated manner. Based on the disclosure and teachings provided herein, a person of ordinary skill in the art may know and appreciate other ways and/or methods to implement the present invention using hardware, software, or a combination of hardware and software.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention. A recitation of “a”, “an” or “the” is intended to mean “one or more” unless specifically indicated to the contrary. Recitation of “and/or” is intended to represent the most inclusive sense of the term unless specifically indicated to the contrary.

One or more of the elements of the present system may be claimed as means for accomplishing a particular function. Where such means-plus-function elements are used to describe certain elements of a claimed system it will be understood by those of ordinary skill in the art having the present specification, figures and claims before them, that the corresponding structure is a general purpose computer, processor, or microprocessor (as the case may be) programmed to perform the particularly recited function using functionality found in any general purpose computer without special programming and/or by implementing one or more algorithms to achieve the recited functionality. As would be understood by those of ordinary skill in the art that algorithm may be expressed within this disclosure as a mathematical formula, a flow chart, a narrative, and/or in any other manner that provides sufficient structure for those of ordinary skill in the art to implement the recited process and its equivalents.

While the present disclosure may be embodied in many different forms, the drawings and discussion are presented with the understanding that the present disclosure is an exemplification of the principles of one or more inventions and is not intended to limit any one of the inventions to the embodiments illustrated.

The present disclosure provides a solution to the long-felt need described above. In particular, the systems and methods described herein may be configured for form processing. Further advantages and modifications of the above described system and method will readily occur to those skilled in the art. The disclosure, in its broader aspects, is therefore not limited to the specific details, representative system and methods, and illustrative examples shown and described above. Various modifications and variations can be made to the above specification without departing from the scope or spirit of the present disclosure, and it is intended that the present disclosure covers all such modifications and variations provided they come within the scope of the following claims and their equivalents.

What is claimed is:

1. A computer-implemented method for creating a meta-structure to a form document comprising:
identifying, by a meta-structure generator, one or more fields in a form document, wherein the form document is executed by a document software;
identifying, by the meta-structure generator, one or more data values from the one or more fields;
assigning, by the meta-structure generator, labels to the one or more fields;
receiving, by the meta-structure generator, data values from a user for the one or more fields; and
in response to an instruction from the user to save the form document, generating, by the meta-structure generator, the meta-structure storing at least a portion of the data values and the corresponding one or more labels, wherein the meta-structure comprises an embedded content not visible to the user when the form document is saved.

2. The computer-implemented method of claim 1, further comprising generating a declaration summary for the form document as part of the meta-structure.

3. The computer-implemented method of claim 2, wherein the declaration summary comprises summary information of the meta-structure.

4. The computer-implemented method of claim 3, wherein the summary information comprises: a starting point of contents of the meta-structure, a size of the content of the meta-structure, and a format of the content of the meta-structure.

5. The computer-implemented method of claim 1, wherein the meta-structure generator comprises an add-on application.

6. The computer-implemented method of claim 1, wherein the meta-structure generator comprises a third-party program.

7. The computer-implemented method of claim 1, wherein the meta-structure generator comprises a standalone software program for reading at least the portion of the data values and not the form document.

8. The computer-implemented method of claim 1, wherein generating comprises generating the meta-structure before the form document is saved and closed by the document software.

9. A computer-implemented method for retrieving data content from a meta-structure in a form document, said form document to be opened by a document software, comprising:
receiving, by a meta-structure generator, a form document, said form document including data fields with data values;
identifying, by the meta-structure generator, the meta-structure,
identifying, by the meta-structure generator, any data retrieval rules associated with the meta-structure before retrieving the data values; and
extracting, by the meta-structure generator, the data values from the meta-structure without triggering the document software to read contents of the form document in its entirety.

10. The computer-implemented method of claim 9, wherein the meta-structure generator comprises an add-on application.

11. The computer-implemented method of claim 9, wherein the meta-structure generator comprises a third-party program.

12. The computer-implemented method of claim 9, wherein the meta-structure generator comprises a standalone software program for reading at least the portion of the data values and not the form document.

13. The computer-implemented method of claim 9, further comprising displaying a container the meta-structure and the contents thereof.

14. The computer-implemented method of claim 13, further comprising reading a declaration summary of the meta-structure to determine a size of the container.

15. A non-transitory computer readable medium for storing computer-executable instructions thereon for retrieving data content from a meta-structure in a form document, said form document to be opened by a document software, said computer-executable instructions comprising:
receiving, by a meta-structure generator, a form document, said form document including data fields with data values;
identifying, by the meta-structure generator, a meta-structure embedded therein,
identifying, by the meta-structure generator, any data retrieval rules associated with the meta-structure before retrieving the data values;
extracting, by the meta-structure generator, the data values from the meta-structure without triggering the document software to read contents of the form document in its entirety; and
transmitting, by the meta-structure generator, the extracted data values to a new form in a different format from that of the form document.

16. The computer readable medium of claim 15, wherein the meta-structure generator comprises an add-on application.

17. The computer readable medium of claim 15, wherein the computer-executable instructions further comprising generating an interactive graphical user interface (GUI) for receiving user instructions prior to transmitting the extracted data values.
